(19) United States
(12) Patent Application Publication
(10) Pub. No.: US 2009/0270564 A1
(43) Pub. Date: Oct. 29, 2009

(54) METHOD FOR THE DIRECT PRODUCTION OF POLYESTER ARTICLES FOR PACKAGING PURPOSES AND ARTICLES OBTAINED THEREFROM

(75) Inventors: Eric Marie Gorlier, Vittel (FR); Klaus Hartwig, Nancy (DE); Ulrich Karl Thiele, Bruchkobel (DE)

Correspondence Address: K&L Gates LLP, P.O. Box 1135, CHICAGO, IL, 60690, US

(73) Assignee: Nestle Waters Management & Technology, Issy-les-Moulineaux (FR)

(21) Appl. No.: 12/293,447

(22) PCT Filed: Mar. 29, 2007
(86) PCT No.: PCT/EP2007/052999

§ 371 Date: Sep. 18, 2008

(30) Foreign Application Priority Data
Mar. 29, 2006 (EP) 06360009.2

(51) Int. Cl. C08G 63/91; C08G 63/183

(52) U.S. Cl. 525/439; 525/437

(57) ABSTRACT

The present invention is related to a method for the direct production of polyester articles for packaging purposes, in particular for the production of hollow bodies, thermoformed sheets and films, said articles containing an amount of acetaldehyde less than 10 ppm. This method is characterised in that it essentially comprises a step in which the initial level SE₀ of the sum of end groups in the polymer melt is increased by adding a mixture of at least one inert and at least one reactive substance to said polymer melt to a second level SE₁ and a degassing step consisting in essentially applying a vacuum to the previously obtained polymer melt to cause a removal of low molecular weight substances present and formed, of non reacted reactive substance(s) and inert substance(s) added during previous step before the so obtained polymer melt is directly converted into the desired articles.

The present invention concerns the field of packaging, more particularly in relation with the packaging of food and beverages.

The present invention is related to a method for the direct conversion of a polyester melt as it is after a melt polycondensation process to articles for packaging purposes, in particular for the production of hollow bodies, thermoformed sheets and films, said articles containing an amount of acetaldehyde less than 10 ppm.

The invention is also directed to the packaging articles obtained by this process.

The production of polyester for the purpose of the manufacture of shaped polyethylene terephthalate food packaging products like hollow bodies, thermoforming sheets and films is described in details for instance in U.S. Pat. No. 4,340,721. The summary of the main teaching of this patent is the melt phase polycondensation of polyester in presence of co-monomers like isopthalic acid, naphthalenedicarboxylic, adipic and/or sebacinic acid, and/or ester-forming derivatives thereof, which is followed by the conversion of the precursor melt to a granulate. This granulate, which is containing higher amounts of acetaldehyde (hereafter referred to as AA) and presents an intrinsic viscosity (hereafter referred to as IV) between 0.55 and 0.70 dl/g is treated in the solid phase polycondensation according to published French Patent FR-A-2 425 455 to increase the intrinsic viscosity to a range between 0.65 and 1.0 dl/g and to reduce the content of acetaldehyde to less than 1.25 ppm.

To overcome the disadvantage of this multistep method containing a melt phase polycondensation, solid phase polycondensation, pre-drying and shaping of packaging products a number of methods have already been suggested to reduce process complexity, energy consumption, material losses and investment cost.

U.S. Pat. No. 5,656,221 describes a method for direct production of shaped packaging material made of thermoplastic polyesters where an inert gas is introduced into the polyester melt and distributed uniformly in the melt immediately after its discharge from the polycondensation reactor. In this method, 0.05 to 1.0 weight % of an amide compound with a low volatility like MXD6 nylon is added to the polyester melt directly next to the gas inlet. Finally, the polyester melt is subjected to a vacuum degassing immediately before the shaping.

U.S. Pat. No. 5,656,719 describes a method for producing bottle preforms from the melt of polyethylene terephthalate and/or its copolyesters, which includes selectively introducing an inert gas into the continuous flow or partial flow of the polyester melt from a poly-condensation having an intrinsic viscosity between 0.5 and 0.75 dl/g, subsequently bringing the melt to an acetaldehyde content below 10 ppm in a melt after-condensation reactor and to an intrinsic viscosity of 0.75 to 0.95 dl/g and thereafter guiding the melt into an injection moulding tool and processing the same.

WO 97/31968 describes a method comprising the steps of a) melt reacting at least one glycol and at least one dicarboxylic acid to form a polyester having an IV of at least about 0.50 dl/g, wherein said at least one glycol is selected from the group consisting of glycols having up to 10 carbon atoms and mixtures thereof and said dicarboxylic is selected from the group consisting of alkyl dicarboxylic acids having 2 to 16 carbon atoms, aryl dicarboxylic acids having 8 to 16 carbon atoms and mixtures thereof, b) forming said polyester into shaped articles directly from step a) and comprising the step of vacuum devolatilizing prior direct melt to mould method for forming polyester articles.

US Patent Application No. 20050161863 describes a method of making shaped articles from a highly condensed polyester melt and especially preforms for the blow moulding of food and especially beverage containers where a melt is continuously withdrawn from the polycondensation reactor and is fed to the shape-imparting units, especially a multiplicity of injection-moulding machines without solidification between the final reactor and the injection moulders and without degassing between the final reactor and the injection moulding machines. To reduce the acetaldehyde content of the polyester melt, the adding of a phosphorus-containing substance or an acetaldehyde-reducing substance or mixture of substances in solid form or as a slurry before said melt enters the moulding unit, is suggested.

The teachings of these inventions comprise the removal of acetaldehyde by injecting inert gas to the polyester melt after the polycondensation reactor, purging and subsequent devolatization of the melt applying a vacuum degassing unit, the addition of acetaldehyde scavenging substances or the combination of both methods. Especially during the last decade it has been discovered that low molecular weight acetaldehyde scavengers have the potential to migrate from the container wall, whereas high molecular weight acetaldehyde scavengers like MXD6-nylon or its oligomers are less active with the result of high application concentration. In any case the use of acetaldehyde scavengers induces additional cost.

It is known that acetaldehyde exists in the polyester melt in two configurations which are firstly solved as free acetaldehyde and secondly chemically bound as vinyl-ester end-groups. It is also known that the vinylester end-groups are preferentially created by dehydration of free OH-end-groups.

To reduce the number of free OH-end-groups and with this, the rebuilding rate of acetaldehyde during the extrusion and injection moulding of state of the art bottle PET produced by melt polycondensation and SSP, U.S. Pat. No. 4,361,681 is suggesting to add phthalic anhydride or succinic anhydride at any time after the melt polycondensation and prior injection moulding. Disadvantage of this process is that the reactive anhydride has to be dosed exactly and the reaction temperature and time must be accurately adjusted to guarantee a 100% conversion of anhydride with the OH-end-groups to avoid that non-reacted anhydride is present in the wall of the beverage container.

Another method to reduce the content of acetaldehyde during melt polycondensation which is described in US patent application 20050049391 is suggesting the addition of special catalyst substances like active vinyl ester transesterification catalysts for catalyzing conversion of the vinyl ester end groups to acetaldehyde, heating the polyester, and providing egress for the acetaldehyde from the polyester. These transesterification catalysts can be selected from the group consisting of Group Ia and Group IIa metals. Disadvantage of this method is that the real source of vinyl ester end groups which are the OH-end-groups is not reduced.

Gas purging and devolatization as well as acetaldehyde scavengers are only removing or absorbing the free acetaldehyde. Disadvantage of the acetaldehyde scavengers are high additive cost and potential migration from the packaging wall. The addition of dianhydrides is reducing the OH-end-groups but does not guarantee that no non-reacted dianhydrides are present in the wall of the final beverage.

The addition of transesterification catalyst which is converting the vinylester end-groups is reducing the source of subsequent acetaldehyde rebuilding but will not reduce the number of OH-end-groups.

Therefore, there is still a need for a method for the direct manufacturing of polyester for packaging from polyester melt derived from polycondensation reactor, in which the packaging polymer can be provided with the desired low content of acetaldehyde without the disadvantages of the described production methods.

The problem of the present invention is solved by a method as described in claim 1.

Special embodiments and advantages are set forth in the depending claims.

The present invention also provides packaging articles with a low acetaldehyde content as claimed in claim 10.

According to the present invention, a method for the direct production of polyester articles for packaging purposes, in particular for hollow bodies, thermoformed sheets and films, said articles containing an amount of acetaldehyde less than 10 ppm is proposed.

The method according to the present invention is essentially comprising the following steps:

a) providing a polyethylene terephthalate based polymer melt which is directly produced by conversion of more than 90 weight % of terephthalic acid or dimethyl terephthalate and ethylene glycol, said polymer melt having an intrinsic viscosity (IV₀) at the outlet of the polycondensation reactor in a range of 0.5 dl/g to 0.90 dl/g, preferably between 0.6 and 0.7 dl/g,

b) adding to said polymer melt, a mixture of at least one inert and at least one reactive substances which reacts with the —COOH and/or —OH and/or —COO—CH═CH₂ end groups of the polyester and/or with the ester bonds of the polyester chain in order to at least cause partial hydrolysis and/or acidolysis and/or alcoholysis and/or ammonolysis and/or hydrazinolysis and/or addition reaction to said end groups combined with acidolysis and/or a combination of these reactions thereby causing an increase of the sum of end groups from an initial level SE₀ at the end of step a) to a first level SE₁ at the end of this step,

c) removing the low molecular weight monomer substances having a molecular weight ≦500 g/mol present and formed, the non-reacted reactive substance(s) and the inert substance(s) added during previous step b) after a reaction time of >1 second and <3600 seconds by submitting the polymer melt to a degassing step consisting in essentially applying a vacuum of 0.05-800 mbar causing a partial polycondensation, which thereby causes a decrease of the sum of end groups from said first level SE₁ to a second sum of end group level SE₂ at the end of this step and,

d) converting directly the previously obtained polymer melt into the desired articles.

The polyester melt of the process according to the present invention is containing up to 10 weight % of one or a mixture of co-monomers selected from the group consisting in:

diethylene glycol, triethylene glycol, isophthalic acid, naphthalene dicarboxylic acid, adipic acid, cyclohexane dimethanol, pyromellitic acid, trimellitic acid, pentaerythrol, neopentylglycol, triethylene glycol tetraethylene glycol, pentaethylene glycol, polyethylenglycol and polypropylenglycol.

According to a first feature of the present invention, the amount of acetaldehyde or AA contained in the polymer melt at the outlet of the polycondensation reactor is comprised between 1 and 150 ppm.

The added amount of reactive substance(s) during step b) is sufficient to reach a first level of the sum of end groups SE₁ after this treatment, which is increased by ≧1% and ≦30%, preferably increased by ≧4% and ≦8% compared to the sum of end group level SE₀ of the polymer melt at the end of step a).

Purpose of the addition of said reactive substances is to provide for an internal washing method which is removing vinyl ester end groups and reducing the number of end groups which are source of vinyl ester end groups.

According to the invention, the adding of a reactive substance or substance mixture to the polymer melt after the polycondensation reactor during step b) is carried out continuously.

Advantageously, the said reactive substance or substance mixture added during step b) is able to react with end groups and/or to terminate ester bondings of the polyester chain within a reaction time of >1 second and <3600 seconds.

According to another feature, said added reactive substance or substance mixture is applied during step b) with an inert gaseous carrier, preferably selected in the group consisting of: nitrogen, hydrogen, helium, argon, carbon dioxide, ethane, propane, butane, n-hexane, cyclohexane or mixtures out of these substances.

According to the invention, the reactive substance or substance mixture added during step b) is selected in the group consisting of:
water, for hydrolysis, and/or
at least one monofunctional or polyfunctional alcohol, preferably selected in the group consisting of: methanol, ethanol, butanol, propanol, isopropanol, isobutanol, ethylene glycol, diethylene glycol, polyethylene glycol and polypropylene glycol, for alcoholysis, and/or
at least one monofunctional or polyfunctional carbonic acid, preferably formic acid, acetic acid and/or propionic acid, for acidolysis, and/or
at least one hydroxycarbonic acid like glycolacid, for the combination of alcoholysis and acidolysis, and/or
at least one primary, secondary or tertiary amines or mixtures of these like ammoniac, monomethylamine and dimethylamine, for aminolyse, and/or
hydrazine and/or its derivatives like 1,1-dimethyhydrazine for hydrazinolysis, and/or
substances which, under the conditions existing in the polyester melt, decay into the described reactive substances, preferably ethylene carbonate, propylene carbonate and/or methylacetate, and/or
at least one anhydride of monocarbonic acids, preferably acetic acid anhydride, isobutyric anhydride or butyric anhydride which reacts in a first step with OH-end-groups under endcapping of these groups and which provides out of this reaction one molecule of carbonic acid per OH-end group for further acidolysis,

and wherein the condition of aggregation of the above described reactive substance or substance mixture is liquid and/or gaseous and/or supercritical.

The reactive substance or substance mixture added during step b) is able to increase the total number of end groups and/or destruct the polymer chain partially and/or react with OH-end-groups under endcapping and/or replace vinyl-ester end groups.

According to another feature of the present invention, the degassing step carried out in step c) is carried out in an environment of 0.05 mbar to 800 mbar, preferably between 0.1 and 10 mbar to remove said added inert substance(s), a possible excess amount of reactive substance(s), the decomposition products caused by said reactive substance(s) and the common split and side products, which may occur during polyester production and wherein the sum of end group SE₂ of the polymer melt after said degassing step is inferior or equal to the end group level SE₁ existing at the beginning of said degassing step.

In the case where the vacuum degassing does not achieve molecular weight increase SE₂ can be equal to SE₁.

As an example, the polymer melt is entered a device like for instance a twin or multi screw extruder or a spiral reactor where the melt is distributed and exposed to a degassing zone containing vacuum environment to remove the non-reactive inert substances, the excess amount of reactive substances, the quoted decomposition products caused by said reactive substances and the common split and side products as referred to above.

Preferably, the levels of sum of end groups in the polymer melt satisfies:

SE₀<SE₁ and SE₀<SE₂ and SE₂<1,3SE₀

wherein

SE₀=level of the sum of end groups at the end of step a),

SE₁=level of the sum of end groups at the end of step b),

SE₂=level of the sum of end groups at the end of step c).

Advantageously, the said step b) is carried out by operating at least one dosing system for common additives like colour, stabilizers, acetaldehyde scavengers, oxygen scavengers, UV absorbers, optical brighteners, antistatic agents and/or surface modificator.

Those systems are well known by the person skilled in the art and do not need to be detailed any further here. After departing the degassing unit, the polyester melt is immediately converted to the desired article for packaging purposes like preforms, bottles or cast films.

The present invention also encompasses polyester articles for packaging purposes with an acetaldehyde content less than 10 ppm, in particular hollow bodies, especially bottles, thermoformed sheets and films, especially cast films, characterised by the fact that they are obtained by a method according to the present invention.

According to the invention the said degassing unit can comprise commonly used dosing systems which feed usually applied additives for colour, stabilizers, acetaldehyde scavengers, oxygen scavengers, UV absorbers, optical brighteners, antistatic agents, surface modification to the polyester melt. Those systems are well known by the person skilled in the art and do not need further description here. After departing the degassing unit the polyester melt is immediately converted to preforms, bottles and cast films.

The present invention will be better understood thanks to the following description and drawing of a preferred embodiment of said invention given as a non limitative example thereof.

The unique figure is a schematical functional representation of the method according to the present invention.

As shown on said figure, a state of the art polycondensation plant or reactor 1 of a daily capacity of 220 t of bottle grade polyester melt was chosen, in which may be carried out the operations of paste preparation, esterification(s), prepolycondensation and in which terephthalic acid, mono ethylene glycol and isopthalic acid may be converted to a base resin with the following specification (at the outlet of the melt finisher or reactor 1):

| | |
|---|---|
| IV: | 0.65 dl/g |
| DEG (diethyleneglycol): | 1.2 weight % |
| IPA (isophtalic acid): | 1.5 weight % |
| Acetaldehyde | 20 ppm |
| COOH end groups in the melt | 26 mequ/kg |
| Color L, a, b (C-Lab) | 85/−1.2/−3 |
| DSC | Tg = 79° C., Tk = 151° C., |
| | Tm = 251° C. |
| Temperature at melt outlet | 281° C. |

The intrinsic viscosity IV is measured under the following conditions: 0.5 g of polyester are dissolved in 0.11 of a solvent consisting of phenol and 1,2-dichlorobenzene (3:2 weight parts), the relative viscosity of this solution is analyzed at 25° C. applying the method of Ubbelohde. The intrinsic viscosity is calculated from the relative viscosity by extrapolation to 0%.

Carboxyl end groups (—COOH) are analyzed by the following method:

The polyester is dissolved during heating in a solvent consisting of 70 weight % o-cresol and of chloroform (70:30 weight parts), and the content of —COOH groups is photometrically determined with 0.05 n of ethanolic potassium hydroxide against bromothymol blue.

Acetaldehyde is analyzed as following:

Analysis of residual of AA in PET packaging (resins, preforms and bottles) is performed by GC-Flame Ionising Detector on the headspace generated by heating grinded material at high temperature into a sealed vial.

Measurement is done according to the AFNOR method XP T90-210 standard defined by the French Ministry of Health, document ref. DGS/PGE/1.D.-n^{o}1526 (December 1999).

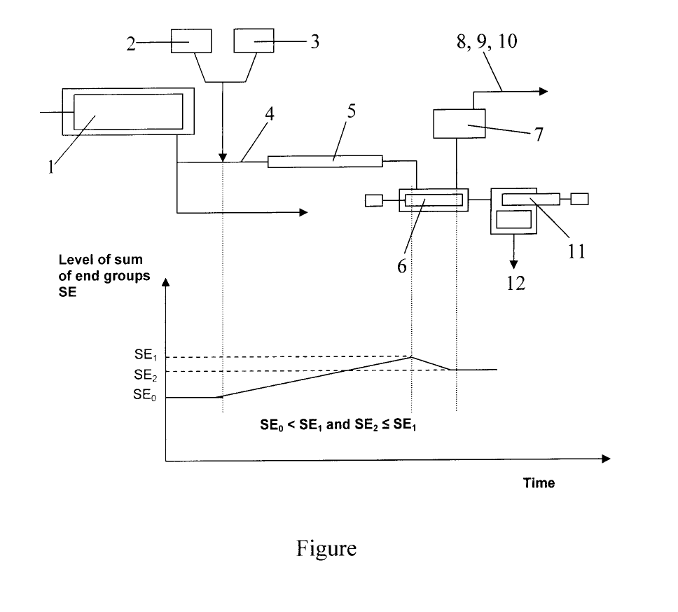

As shown in FIG. 1, the main melt pipe guiding the melt to the cutter was connected with an outlet equipped with a metering pump to feed about 500 kg/h melt to the direct preform method. The adding of reactive and inert substances from the inert substance reservoir 2 and a reactive substance reservoir 3 and thanks to adapted feeding means (unrepresented) to said pipe is executed according to the figures listed in table 1. After feeding the reactive and inert substances to the melt pipe 4, a column 5 of static mixers containing 14 elements is distributing said added substances evenly. After the mixing column 5 and a residence time of 60 seconds the melt is entering a multiple screw 6 extruder where the applied vacuum from vacuum device 7 is removing any undesired volatile inert substance 8, remaining reactive substance 9 and/or common side products 10 of polyester production like acetaldehyde and ethylene glycol. The melt coming from said multiple screw 6, which is acting as a degassing unit, is instantaneously fed into the forming machine 11 and converted into formed articles 12.

In table 1 the results of the examples 1 to 7 and the comparative examples V1-V2 are described for a polyester article for packaging purposes which consists in a conventional preform.

TABLE 1
Examples

| | | | AA | | | | Pressure in | | | |
|---|---|---|---|---|---|---|---|---|---|---|
| | | | level | Reactive | Inert | | vacuum | | COOH SE₂ | AA |
| | | COOH | in | Substance/ | Substance/ | Melt | Degassing- | IV of | level in | level in |
| Exam- | IV₀ | SE₁ | Melt | flow | flow | Flow | unit | preform | preform | preform |
| ples | [dl/g] | [mequ/kg] | [ppm] | [ppm] | [l/h] | [kg/h] | [mbar] | [dl/g] | [meq/kg] | [ppm] |
| 1 | 0.650 | 30 | 15 | H₂O/500 | N₂/200 | 420 | 0.5 | 0.612 | 32 | 6 |
| 2 | 0.650 | 32 | 15 | H₂O/500 | CO₂/200 | 420 | 0.5 | 0.611 | 33 | 5 |
| 3 | 0.650 | 31 | 15 | Hac/500 | N₂/300 | 420 | 0.8 | 0.613 | 34 | 5 |
| 4 | 0.650 | 31 | 15 | NH₃/200 | N₂/300 | 420 | 0.5 | 0.615 | 31 | 3 |
| 5 | 0.650 | 30 | 15 | MeOH/400 | CO₂/300 | 420 | 0.6 | 0.611 | 32 | 5 |
| 6 | 0.650 | 28 | 15 | Hyz/300 | CO₂/400 | 420 | 0.5 | 0.612 | 31 | 3 |
| 7 | 0.650 | 31 | 15 | AcAn/400 | N₂/400 | 420 | 0.5 | 0.620 | 32 | 2 |
| V1 | 0.650 | 26 | 15 | none | N₂/200 | 420 | 0.5 | 0.648 | 27 | 9 |
| V2 | 0.650 | 27 | 15 | none | CO₂/200 | 420 | 0.5 | 0.646 | 28 | 10 |

(Hac = acetic acid; Hyz = hydrazine; AcAn = acetic acid anhydride)

All examples of table 1 have the same SE₀=26 mequ/kg.

As can clearly been seen from table 1, the preforms of the invention contain up to 5 times less AA as the preforms of comparative examples V1 and V2.

The present invention is, of course, not limited to the preferred embodiment described and represented herein, changes can be made or equivalents used without departing from the scope of the invention defined by the claims.

1. Method for the production of polyester articles for packaging purposes, containing an amount less than 10 ppm of acetaldehyde, consisting of essentially the following steps:
a) providing a polyethylene terephthalate based polymer melt which is directly produced by conversion of more than 90 weight % of terephthalic acid or dimethyl terephthalate and ethylene glycol, the polymer melt having an intrinsic viscosity (IV₀) at an outlet of a polycondensation reactor in a range of 0.5 dl/g to 0.90 dl/g;
b) adding to sad the polymer melt, a mixture of at least one inert and at least one reactive substances which reacts with at least one of the groups selected from the group consisting of the —COOH, —OH, —COO—CH═CH₂ end groups of the polyester and the ester bonds of the polyester chain in order to cause an increase of the sum of end groups from an initial level SE₀ at the end of step a) to a first level SE₁ at the end of his step b); and
c) removing low molecular weight monomer substances having a molecular weight of not greater than 500 g/mol present and formed, the non-reacted reactive substance(s) and the inert substance(s) added during step b) after a reaction time of greater than 1 second and less than 3600 seconds by subjecting the polymer melt to a degassing step comprising applying a vacuum of 0.05-800 mbar causing a partial polycondensation, which thereby causes a decrease of the sum of end groups from said first level SE₁ to a second sum of end group level SE₂ at the end of this step; and
d) converting directly the obtained polymer melt into desired articles.

2. Method according to claim 1, wherein the polyester melt comprises up to 10 weight % of one or a mixture of co-monomers selected from the group consisting of:
diethylene glycol, triethylene glycol, isophthalic acid, naphthalene dicarboxylic acid, adipic acid, cyclohexane dimethanol, pyromellitic acid, trimellitic acid, pentaerythrol, neopentylglycol, triethylene glycol tetraethylene glycol, pentaethylene glycol, polyethylenglycol and polypropylenglycol.

3. Method according to claim 1, wherein the amount of acetaldehyde contained in the polymer melt at the outlet of the polycondensation reactor is between 1 and 150 ppm.

4. Method according to claim 1, wherein the added amount of reactive substance(s) during step b) is sufficient to reach a first level of the sum of end groups SE₁ after step b, which is increased by ≧1% and ≦30% compared to the sum of end group level SE₀ of the polymer melt at the end of step a).

5. Method according to claim 1, wherein the step of adding of a reactive substance or substance mixture to the polymer melt after the polycondensation reactor during step b) is carried out continuously.

6. Method according to claim 1, wherein the added reactive substance or substance mixture is applied during step b) with an inert gaseous carrier.

7. Method according to claim 1, wherein the reactive substance or substance mixture added during step b) is selected from the group consisting of:
water for hydrolysis,
at least one monofunctional or polyfunctional alcohol,
at least one monofunctional or polyfunctional carbonic acid
at least one hydroxycarbonic acid,
at least one primary, secondary or tertiary amines or mixtures of these,
hydrazine and/or its derivatives,
substances which, under the conditions existing in the polyester melt, decay into the described reactive substances, and
at least one anhydride of monocarbonic acids,
and wherein the condition of aggregation of the above described reactive substance or substance mixture is selected from the group consisting of liquid gaseous and supercritical.

8. Method according to claim 1, wherein the degassing step carried out in step c) is carried out in an atmosphere of 0.1 to 10 mbar.

9. Method according to claim 1, wherein the levels of sum of end groups in the polymer melt satisfies:
SE₀<SE₁ and SE₀<SE₂ and SE₂<1,3SE₀
wherein
SE₂=level of the sum of end groups at the end of step a),
SE₁=level of the sum of end groups at the end of step b), and
SE₂=level of the sum of end groups at the end of step c).

10. Polyester articles for packaging purposes comprising an acetaldehyde content of less than 10 ppm, provided by a method consisting of essentially the following steps:
a) providing a polyethylene terephthalate based polymer melt which is directly produced by conversion of more than 90 weight % of terephthalic acid or dimethyl terephthalate and ethylene glycol, the polymer melt having an intrinsic viscosity (IV₀) at an outlet of a polycondensation reactor in a range of 0.5 dl/g to 0.90 dl/g;
b) adding to the polymer melt, a mixture of at least one inert and at least one reactive substances which reacts with at least one of the groups selected from the group consisting of the —COOH, —OH, —COO—CH═CH₂ end groups of the polyester and the ester bonds of the polyester chain in order to cause an increase of the sum of end groups from an initial level SE₀ at the end of step a) to a first level SE₁ at the end of step b);
c) removing low molecular weight monomer substances having a molecular weight ≦500 g/mol present and formed, the non-reacted reactive substance(s) and the inert substance(s) added during step b) after a reaction time of >1 second and <3600 seconds by subjecting the polymer melt to a degassing step comprising applying a vacuum of 0.05-800 mbar causing a partial polycondensation, which thereby causes a decrease of the sum of end groups from said first level SE₁ to a second sum of end group level SE₂ at the end of this step; and
d) converting directly the obtained polymer melt into desired articles.

11. Method for the production of polyester articles comprising less than 10 ppm acetaldehyde, comprising the steps:
a) providing a polyethylene terephthalate based polymer melt which is produced by conversion of more than 90 weight % of terephthalic acid or dimethyl terephthalate and ethylene glycol, the polymer melt having an intrinsic viscosity (IV₀) at the outlet of the polycondensation reactor in a range of 0.5 dl/g to 0.90 dl/g;
b) adding to the polymer melt, a mixture of at least one inert and at least one reactive substances which reacts with the —COOH, —OH, or —COO—CH═CH₂ end groups of the polyester and/or with the ester bonds of the polyester chain thereby causing an increase of the sum of end groups from an initial level SE₀ at the end of step a) to a first level SE₁ at the end of step b),
c) removing low molecular weight monomer substances that are formed and have a molecular weight of not greater than 500 g/mol, the non-reacted reactive substance(s) and the inert substance(s) added during step b) after a reaction time of less than 3600 seconds by subjecting the polymer melt to a degassing step causing a decrease of the sum of end groups from the first level SE₁ to a second sum of end group level SE₂ at the end of step c); and
d) converting directly the polymer melt into the desired articles.

12. Method according to claim 1, wherein the added amount of reactive substance(s) during step b) is sufficient to reach a first level of the sum of end groups SE₁ after this step, which is increased by between 4% and 8% compared to the sum of end group level SE₀ of the polymer melt at the end of step a).

13. Method according to claim 1, wherein the added reactive substance or substance mixture is applied during step b) with an inert gaseous selected from the group consisting of: nitrogen, hydrogen, helium, argon, carbon dioxide, ethane, propane, butane, n-hexane, cyclohexane or mixtures out of these substances.

14. Method according to claim 1, wherein the reactive substance or substance mixture added during step b) is selected in the group consisting of:
water for hydrolysis;
at least one monofunctional or polyfunctional alcohol, selected from the group consisting of: methanol, ethanol, butanol, propanol, isopropanol, isobutanol, ethylene glycol, diethylene glycol, polyethylene glycol and polypropylene glycol, for alcoholysis;
at least one monofunctional or polyfunctional carbonic acid selected from the group consisting of formic acid, acetic acid and propionic acid;
at least one hydroxycarbonic acid;
at least one primary, secondary or tertiary amines or mixtures;
hydrazine and/or its derivatives;
substances which, under the conditions existing in the polyester melt, decay into the described reactive substances selected from the group consisting of ethylene carbonate, propylene carbonate and methylacetate; and
at least one anhydride of monocarbonic acids, selected from the group consisting of acetic acid anhydride, isobutyric anhydride and butyric anhydride.
